(19) United States
(12) Patent Application Publication
(10) Pub. No.: US 2020/0040170 A1
(43) Pub. Date: Feb. 6, 2020

(54) RUBBER COMPOSITION MADE FROM A HIGHLY SATURATED DIENE ELASTOMER AND A DITHIOSULFATE SALT

(71) Applicant: COMPAGNIE GENERALE DES ETABLISSEMENTS MICHELIN, Clermont-Ferrand (FR)

(72) Inventors: José-Carlos ARAUJO DA SILVA, Clermont-Ferrand Cedex 9 (FR); Aurélie TRIGUEL, Clermont-Ferrand Cedex 9 (FR); Aurore CROCHET, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/604,043

(22) PCT Filed: Apr. 5, 2018
(86) PCT No.: PCT/FR2018/050850

§ 371 Date: Oct. 9, 2019

(30) Foreign Application Priority Data
Apr. 10, 2017 (FR) 17/53107

(51) Int. Cl. C08L 23/08; B60C 1/00; C08F 210/02; C08K 5/41; C08J 3/20

(52) U.S. Cl. CPC C08L 23/083; B60C 1/00; C08F 2800/10; C08K 5/41; C08J 3/203; C08F 210/02

(57) ABSTRACT

A rubber composition based at least on an elastomer matrix, on a reinforcing filler and on a vulcanization system is provided. The elastomer matrix comprises a highly saturated elastomer and from 0 to less than 30 phr of natural rubber. The highly saturated diene elastomer contains 1,3-diene units and more than 50 mol % of ethylene units. The vulcanization system comprises a dithiosulfate salt of formula MO₃S—S-A-S—SO₃M in which the symbol A represents an alkanediyl group or a group comprising two or more alkanediyl units, which units are connected in pairs via an oxygen or sulfur atom, via a group of formula —SO₂—, —NH—, —NH₂⁺—, —N(C₁-C₁₆ alkyl)- or —COO—, or via an arylene or cycloalkylene group, and the symbol M represents a metal atom. The invention makes it possible to achieve an improved compromise between bubble formation in the rubber composition on exiting from the curing presses and its hysteresis.

This application is a 371 national phase entry of PCT/FR2018/050850 filed on 5 Apr. 2018, which claims benefit of French Patent Application No. 17/53107, filed 10 Apr. 2017, the entire contents of which are incorporated herein by reference for all purposes.

### BACKGROUND

### 1. Technical Field

The present invention relates to diene rubber compositions, which can be used in particular in the manufacture of tires.

### 2. Related Art

Ideally, a rubber composition intended to be used in a tire has to meet a large number of often conflicting technical requirements, for example has to exhibit a high stiffness and a low hysteresis.

It is known, from Patent Application WO 2014114607, that a more rigid composition can be obtained by replacing the highly unsaturated diene elastomers, that is to say comprising more than 50 mol % of diene unit, with highly saturated elastomers containing more than 50 mol % of ethylene unit. These highly saturated elastomers also exhibit the advantage of conferring, on the rubber compositions, a compromise between the stiffness and hysteresis properties different from the highly unsaturated diene elastomers conventionally used in rubber compositions, such as, for example, polybutadienes, polyisoprenes and copolymers of butadiene and of styrene.

For one and the same elastomer, the level of stiffness of the rubber composition is also defined by the degree of vulcanization of the elastomer, which depends both on the vulcanization kinetics and the residence time of the rubber composition in the curing press. It is known that rubber compositions continue to cure, even once they have been removed from the curing presses. The continuation of the curing outside the presses is all the greater as the rubber composition exists in the form of a bulk object. If the stiffening of the rubber composition is not sufficient on exiting from the press, the viscosity of the rubber composition then makes possible bubble formation within the rubber composition when the curing continues outside the press. Bubble formation within the rubber composition represents defects in homogeneity in the rubber composition and can result in a decrease in the endurance of the tire containing the rubber composition. It is thus desirable for the rubber composition, at the end of curing in the press, to have achieved a stiffness sufficient to prevent the formation of bubbles.

Highly saturated elastomers which contain more than 50 mol % of ethylene unit have the distinguishing feature of vulcanizing according to slower kinetics than highly unsaturated elastomers which contain more than 50 mol % of diene units. Longer residence times in the curing presses are thus necessary in order to vulcanize rubber compositions containing highly saturated elastomers, especially if it is desired to avoid the abovementioned bubbling phenomena. The lower reactivity of highly saturated elastomers with regard to the vulcanization is thus expressed by a longer occupation time of the presses per rubber composition and thus longer production cycles, which has the effect of reducing the productivity of tire manufacturing sites.

In order to reduce the residence time in the presses without being to the detriment of the stiffness of the rubber composition, it is known to use an activator for vulcanization of diene elastomers, such as diphenylguanidine, which makes it possible to reduce the delay phase of the vulcanization. Unfortunately, the use of diphenylguanidine leads to an increase in the hysteresis of the rubber composition, which is harmful for a good rolling resistance performance of the tire.

### SUMMARY

The Applicant Company, continuing its research studies, has found a solution for reducing the residence time in the press with a compromise between the stiffness and hysteresis properties of the rubber composition which is less penalizing than the use of diphenylguanidine.

Thus, a first subject-matter of the invention is a rubber composition based at least on an elastomer matrix, on a reinforcing filler and on a vulcanization system, the elastomer matrix comprising a highly saturated elastomer and from 0 to less than 30 phr of natural rubber, the highly saturated diene elastomer containing 1,3-diene units and more than 50 mol % of ethylene units, the vulcanization system comprising a dithiosulfate salt of formula (I):

MO_{S}S—S-A-S—SO₃M (I)

the symbol A representing an alkanediyl group or a group comprising two or more alkanediyl units, which units are connected in pairs via an oxygen or sulfur atom, via a group of formula —SO₂—, —NH—, —NH₂⁺—, —N(C₁-C₁₆ alkyl)- or —COO—, or via an arylene or cycloalkylene group, and the symbol M representing a metal atom.

The invention also relates to a process for manufacturing the rubber composition in accordance with the invention which comprises the following stages:
a) incorporating, in the elastomer matrix, the reinforcing filler and, if appropriate, other ingredients of the rubber composition, with the exception of the dithiosulfate salt, of the sulfur and of vulcanization accelerator constituting the vulcanization system,
b) thermomechanically kneading the mixture obtained in stage a) until a maximum temperature of between 110° C. and 190° C. is reached,
c) cooling the combined mixture to a temperature of less than 100° C.,
d) subsequently incorporating the dithiosulfate salt, the sulfur and the vulcanization accelerator,
e) kneading everything up to a maximum temperature of less than 110° C., in order to obtain a rubber composition.

### DETAILED DESCRIPTION OF EXAMPLE EMBODIMENTS

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The compounds mentioned in the description can be of fossil or biobased origin. In the latter case, they can partially or completely result from biomass or be obtained from renewable starting materials resulting from biomass. Elastomers, plasticizers, fillers, and the like, are concerned in particular.

In the present patent application, “elastomer matrix” is understood to mean all of the elastomers present in the rubber composition. The expression “part by weight per hundred parts by weight of elastomer” (or phr) should be understood as meaning, within the meaning of the present invention, the portion by weight per hundred parts of elastomer present in the rubber composition.

In the present patent application, “all of the monomer units of the elastomer” is understood to mean all of the constituent repeat units of the elastomer which result from the insertion of the monomers into the elastomer chain by polymerization.

The highly saturated elastomer comprises ethylene units resulting from the polymerization of ethylene. In a known way, the expression “ethylene unit” refers to the —(CH₂—CH₂)— unit resulting from the insertion of ethylene into the elastomer chain. The highly saturated elastomer is rich in ethylene unit, since the ethylene units represent more than 50 mol % of all of the monomer units of the highly saturated elastomer. Preferably, they represent more than 60 mol % of all of the monomer units of the highly saturated elastomer. More preferably, the content of ethylene unit in the highly saturated elastomer is at least 65 mol % of all of the monomer units of the elastomer. In other words, the highly saturated elastomer contains more than 60 mol % of ethylene unit, preferably at least 65 mol % of ethylene unit.

The highly saturated elastomer also comprises 1,3-diene units resulting from the polymerization of a 1,3-diene. In a known way, the expression “1,3-diene unit” refers to the units resulting from the insertion of the 1,3-diene by a 1,4-addition, a 1,2-addition or a 3,4-addition in the case of isoprene. The 1,3-diene units are those, for example, of a 1,3-diene having from 4 to 12 carbon atoms, such as 1,3-butadiene, isoprene, 1,3-pentadiene or an aryl-1,3-butadiene. Preferably, the 1,3-diene is 1,3-butadiene.

According to a first embodiment of the invention, the highly saturated elastomer contains UD units of formula (I) and, if appropriate, can contain UE units of formula (II):

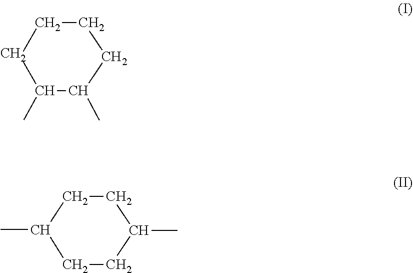

Preferably, the highly saturated elastomer contains the following units UA, UB, UC, UD and UE distributed randomly according to the molar percentages shown below:

UA) —CH₂—CH₂— according to a molar percentage of m %
UB) —CH₂—CH═CH—CH₂— according to a molar percentage of n %
UC) —CH₂—CH(CH═CH₂)— according to a molar percentage of o %

### UD)

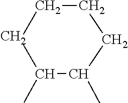

according to a molar percentage of p %

### UE)

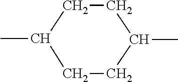

according to a molar percentage of q %
m, n, o, p and q being numbers ranging from 0 to 100,
m>50
n+o>0
p>0
q≥0,
the respective molar percentages of m, n, o, p and q being calculated on the basis of the sum of m+n+o+p+q, which is equal to 100.

More preferably:
0<o+p≤25
o+p+q≥5
n+o>0
q≥0,
the respective molar percentages of m, n, o, p and q being calculated on the basis of the sum of m+n+o+p+q, which is equal to 100.

More preferably still, the highly saturated elastomer exhibits at least one and preferably all of the following criteria:
m≥65
n+o+p+q≥15, preferably n+o+p+q≥20
10≥p+q≥2
1≥n/(o+p+q)
when q is non-zero, 20≥p/q≥1.

Advantageously, q is equal to 0.

The highly saturated elastomer is preferably a copolymer of ethylene and of 1,3-butadiene.

Whatever the embodiment of the invention, including in the alternative forms, the highly saturated elastomer is preferably random.

The highly saturated elastomer can be obtained according to various synthesis methods known to a person skilled in the art, in particular as a function of the targeted values of m, n, o, p, q and r. Generally, it can be prepared by copolymerization of at least one 1,3-diene, preferably 1,3-butadiene, and of ethylene and according to known synthesis methods, in particular in the presence of a catalytic system comprising a metallocene complex. Mention may be made, in this respect, of catalytic systems based on metallocene complexes, which catalytic systems are described in the documents EP 1 092 731, WO 2004/035639, WO 2007/054223 and WO 2007/054224 on behalf of the Applicant Company.

The highly saturated elastomer of use for the requirements of the invention can consist of a mixture of highly saturated diene elastomers which differ from one another in their microstructures or in their macrostructures.

The rubber composition can contain, in addition to the highly saturated elastomer, a second diene elastomer. Diene elastomer is understood to mean an elastomer composed at least in part (i.e., a homopolymer or a copolymer) of diene monomer units (monomers bearing two conjugated or non-conjugated carbon-carbon double bonds). The second elastomer can be selected from the group of highly unsaturated diene elastomers consisting of polybutadienes, polyisoprenes, butadiene copolymers, isoprene copolymers and their mixture. A highly unsaturated elastomer refers to an elastomer which contains more than 50 mol % of diene unit. If the second diene elastomer is a natural rubber, the content of natural rubber is greater than or equal to 0 phr and less than 30 phr.

The content of the highly saturated elastomer in the rubber composition is preferably greater than 70 phr, more preferably greater than 90 phr.

The dithiosulfate salt of use for the requirements of the invention is a compound which bears two —S—SO₃M groups and corresponds to the formula (I):

MO_{S}S—S-A-S—SO₃M (I)

the symbol A representing an alkanediyl group or a group comprising two or more alkanediyl units, which units are connected in pairs via an oxygen or sulfur atom, via a group of formula —SO₂—, —NH—, —NH₂⁺—, —N(C₁-C₁₆ alkyl)- or —COO—, or via an arylene or cycloalkylene group, and the symbol M representing a metal atom. The dithiosulfate salt can exist in the form of one of its hydrates, in particular monohydrate or dihydrate.

The term “C₁-C₁₆ alkyl” is understood to mean an alkyl which contains from 1 to 16 carbon atoms.

The dithiosulfate salt belongs to the family of compounds which bear at least two —SSO₃M groups, which compounds are well known since they are used as anti-reversion agent in rubber compositions based on natural rubber. The Applicant Company has discovered that the salt of formula (I) acts as activator of the vulcanization of highly saturated elastomers containing more than 50 mol % of ethylene unit. The use of the salt thus makes it possible to reduce the residence time in the curing press of a rubber composition containing the highly saturated elastomer while conferring, on the rubber composition, an acceptable compromise between the stiffness and hysteresis properties. Likewise, this compromise is improved in comparison with that obtained in the case where a well-known vulcanization activator, such as diphenylguanidine, is used instead. The use of the dithiosulfate salt as activator in the rubber composition is all the more advantageous since the rubber composition is rich in the highly saturated elastomer. A composition is referred to as rich in the highly saturated elastomer provided that it contains more than 70 phr of the highly saturated elastomer, preferably more than 90 phr of the highly saturated elastomer.

The metal atom represented by the symbol M can be an alkali metal atom, an alkaline earth metal atom or a transition metal atom. The symbol M preferably denotes an alkali metal atom, more preferably a sodium or potassium atom, more preferably still a sodium atom.

The symbol A preferably denotes an alkanediyl group of formula —(CH₂)ₙ—, n being an integer ranging from 3 to 10, more preferably a 1,6-hexanediyl group.

The content of dithiosulfate salt used in the rubber composition is adjusted by a person skilled in the art as a function of the residence time desired in the press and as a function of the stiffness desired for the rubber composition. It can typically vary within a range extending from 0.5 to 5 phr, preferably from 0.8 to 2 phr. The amount is expressed for the molecule of formula (I). In the case where the thiosulfate salt is used in the form of a hydrate, the portion of the water molecule or of the water molecules in the hydrate form must be taken into account in order to satisfy the correct content of the dithiosulfate salt of formula (I).

The vulcanization system is a crosslinking system based on sulfur (or on a sulfur-donating agent) and on a vulcanization accelerator, in particular a primary accelerator. Additional to this base vulcanization system are various known secondary vulcanization accelerators or vulcanization activators, such as zinc oxide or stearic acid, incorporated during the first non-productive phase and/or during the productive phase, as are described subsequently.

The sulfur is used at a preferred content of between 0.5 and 12 phr, in particular between 1 and 10 phr. The primary vulcanization accelerator is used at a preferred content of between 0.5 and 10 phr, more preferably of between 0.5 and 5 phr.

Use may be made, as (primary or secondary) accelerator, of any compound capable of acting as vulcanization accelerator for diene elastomers in the presence of sulfur, in particular accelerators of the type of the thiazoles and also their derivatives, especially accelerators of sulfenamide types. Mention may in particular be made, by way of examples of such accelerators, of the following compounds: N-cyclohexyl-2-benzothiazolesulfenamide (“CBS”), N,N-dicyclohexyl-2-benzothiazolesulfenannide (“DCBS”), N-(tert-butyl)-2-benzothiazolesulfenamide (“TBBS”) and the mixtures of these compounds.

The reinforcing filler can comprise any type of filler known for its abilities to reinforce a rubber composition which can be used in the manufacture of tires, for example an organic filler, such as carbon black, a reinforcing inorganic filler, such as silica, with which is combined, in a known way, a coupling agent, or else a mixture of these two types of filler.

Such a reinforcing filler typically consists of nanoparticles, the (weight-) average size of which is less than a micrometre, generally less than 500 nm, most often between 20 and 200 nm, in particular and more preferably between 20 and 150 nm.

All carbon blacks, in particular the blacks conventionally used in the rubber compositions which can be used in tire manufacture (“tire-grade” blacks), are suitable as carbon blacks. The carbon blacks can be used in the isolated state, as available commercially, or in any other form, for example as support for some of the rubber additives used. Mention may more particularly be made of the reinforcing carbon blacks of the 100 and 200 or 300 series, or of the blacks of the 500, 600 or 700 series (ASTM grades).

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a diene rubber composition intended for the manufacture of pneumatic tires, in other words capable of replacing, in its reinforcing role, a conventional tire-grade carbon black; such a filler is generally characterized, in a known way, by the presence of hydroxyl (OH) groups at its surface.

Preferably, the content of total reinforcing filler is between 20 and 200 phr, more preferably between 30 and 150 phr, the optimum being, in a known way, different depending on the particular applications targeted: the level of reinforcement expected with regard to a bicycle tire, for example, is of course less than that required with regard to a tire capable of running at high speed in a sustained manner, for example a motorcycle tire, a tire for a passenger vehicle or a tire for a utility vehicle, such as a heavy duty vehicle.

The rubber composition can also comprise all or part of the usual additives generally used in elastomer compositions which can be used in the manufacture of tires. These additives can, for example, be plasticizers or extender oils, whether the latter are aromatic or non-aromatic in nature, in particular very weakly aromatic or non-aromatic oils (e.g., paraffin oils, hydrogenated naphthenic oils, MES oils or TDAE oils), vegetable oils, in particular glycerol esters, such as glyceryl trioleates, pigments or protective agents, such as antiozone waxes, chemical antiozonants or antioxidants.

The rubber composition can be manufactured in appropriate mixers, using two successive phases of preparation according to a general procedure well known to a person skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically of less than 110° C., for example between 40° C. and 100° C., during which finishing phase the sulfur or the sulfur donor and the vulcanization accelerator are incorporated.

By way of example, the first (non-productive) phase is carried out in a single thermomechanical stage during which all the necessary constituents, the optional supplementary processing aids and various other additives, with the exception of the dithiosulfate salt, the sulfur or the sulfur donor and the vulcanization accelerator, are introduced into an appropriate mixer, such as an ordinary internal mixer. The total duration of the kneading, in this non-productive phase, is preferably between 1 and 15 min. After cooling the mixture thus obtained during the first non-productive phase, the dithiosulfate salt, the sulfur or the sulfur donor and the vulcanization accelerator are then incorporated at low temperature, generally in an external mixer, such as an open mill; everything is then mixed (productive phase) for a few minutes, for example between 2 and 15 min.

According to a preferred embodiment of the invention, the rubber composition in accordance with the invention is prepared by a process which comprises the following stages:
a. incorporating, in the elastomer matrix, the reinforcing filler and, if appropriate, other ingredients of the rubber composition, with the exception of the dithiosulfate salt, of the sulfur and of vulcanization accelerator constituting the vulcanization system,
b. thermomechanically kneading the mixture obtained in stage a) until a maximum temperature of between 110° C. and 190° C. is reached,
c. cooling the combined mixture to a temperature of less than 100° C.,
d. subsequently incorporating the dithiosulfate salt, the sulfur and the vulcanization accelerator,
e. kneading everything up to a maximum temperature of less than 110° C., in order to obtain a rubber composition,

The rubber composition can be either in the raw state (before vulcanization) or in the cured state (after vulcanization).

A better understanding of the abovementioned characteristics of the present invention, and also others, will be obtained on reading the following description of several implementational examples of the invention, given by way of illustration and without limitation.

### IMPLEMENTATIONAL EXAMPLES OF THE INVENTION

### 1 Tests and Measurements:

### 1-1 Determination of the Microstructure of the Elastomers:

The microstructure of the elastomers is determined by ¹H NMR analysis, compensated for by the ¹³C NMR analysis when the resolution of the ¹H NMR spectra does not make it possible to assign and quantify all the entities. The measurements are carried out using a Bruker 500 MHz NMR spectrometer at frequencies of 500.43 MHz for observing the proton and 125.83 MHz for observing the carbon.

For the elastomers which are insoluble but which have the ability to swell in a solvent, an HRMAS 4 mm z-grad probe, which makes it possible to observe the proton and the carbon in proton-decoupled mode, is used. The spectra are acquired at spin speeds of 4000 Hz to 5000 Hz.

For the measurements on soluble elastomers, a liquid NMR probe, which makes it possible to observe the proton and the carbon in proton-decoupled mode, is used.

The insoluble samples are prepared in rotors filled with the material analysed and a deuterated solvent which makes swelling possible, in general deuterated chloroform (CDCl₃). The solvent used must always be deuterated and its chemical nature can be adapted by a person skilled in the art. The amounts of material used are adjusted so as to obtain spectra with a sufficient sensitivity and resolution.

The soluble samples are dissolved in a deuterated solvent (approximately 25 mg of elastomer in 1 ml), in general deuterated chloroform (CDCl₃). The solvent or solvent blend used must always be deuterated and its chemical nature can be adapted by a person skilled in the art. In both cases (soluble sample or swollen sample):

For proton NMR, a simple 30° pulse sequence is used. The spectral window is adjusted in order to observe all of the resonance lines belonging to the molecules analysed. The accumulation number is adjusted in order to obtain a signal to noise ratio which is sufficient for the quantification of each unit. The recycle delay between each pulse is adapted in order to obtain a quantitative measurement.

For carbon NMR, a simple 30° pulse sequence is used with proton decoupling only during the acquisition in order to avoid the “nuclear Overhauser” effects (NOE) and to remain quantitative. The spectral window is adjusted in order to observe all of the resonance lines belonging to the molecules analysed. The accumulation number is adjusted in order to obtain a signal to noise ratio which is sufficient for the quantification of each unit. The recycle delay between each pulse is adapted in order to obtain a quantitative measurement.

The NMR measurements are carried out at 25° C.

### 1-2 Determination of the Macrostructure of the Elastomers:

Size exclusion chromatography (SEC) is used. SEC makes it possible to separate macromolecules in solution according to their size through columns filled with a porous gel. The macromolecules are separated according to their hydrodynamic volume, the bulkiest being eluted first. Without being an absolute method, SEC makes it possible to comprehend the distribution of the molar masses of a polymer. The various number-average molar masses (Mn) and weight-average molar masses (Mw) can be determined from commercial standards and the polydispersity index (PI=Mw/Mn) can be calculated via a “Moore” calibration.

Preparation of the Polymer:

There is no specific treatment of the polymer sample before analysis. The latter is simply dissolved, in tetrahydrofuran+1 vol % of diisopropylamine+1 vol % of triethylamine+1 vol % of distilled water or in chloroform, at a concentration of approximately 1 g/l. The solution is then filtered through a filter with a porosity of 0.45 μm before injection.

Sec Analysis:

The apparatus used is a Waters Alliance chromatograph. The elution solvent is tetrahydrofuran+1 vol % of diisopropylamine+1 vol % of triethylamine or chloroform, according to the solvent used for the dissolution of the polymer. The flow rate is 0.7 ml/min, the temperature of the system is 35° C. and the analytical time is 90 min. A set of four Waters columns in series, with commercial names “Styragel HMW7”, “Styragel HMW6E” and two “Styragel HT6E”, is used.

The volume of the solution of the polymer sample injected is 100 The detector is a Waters 2410 differential refractometer and the software for making use of the chromatographic data is the Waters Empower system.

The calculated average molar masses are relative to a calibration curve produced from PSS Ready Cal-Kit commercial polystyrene standards.

### 1-3 Dynamic Properties:

The dynamic properties are measured on a viscosity analyser (Metravib VA4000) according to Standard ASTM D 5992-96. The response of a sample of vulcanized composition (cylindrical test specimen with a height of 4 mm and a cross section of 400 mm²), subjected to a simple alternating sinusoidal shear stress, at a frequency of 10 Hz, at 60° C., is recorded. A strain amplitude sweep is carried out from 0.1% to 100% (outward cycle) and then from 100% to 0.1% (return cycle). The results made use of are the complex dynamic shear modulus G* and the loss factor tan(δ). The value of the G* at 50% strain and also the loss factor, tan(δ)max, are recorded on the return cycle.

### 1-4 Vulcanization Properties:

The measurements are carried out at 150′C with an oscillating disc rheometer, according to Standard DIN 53529—Part 3 (June 1983). The change in the rheometric torque as a function of the time describes the change in the stiffening of the composition as a result of the vulcanization reaction. The measurements are processed according to Standard DIN 53529—Part 2 (March 1983). Ti is the induction period, that is to say the time necessary for the start of the vulcanization reaction, Ta (for example T95) is the time necessary to achieve a conversion of α %, that is to say α % (for example 95%) of the difference between the minimum and maximum torques.

### 2 Preparation of the Rubber Compositions:

Fourteen rubber compositions C1, C2, C3, C4, C5, C6, C7, C8, I1, I2, I3, I4, I5 and I6, the breakdown of the formulation of which appears in Tables 1 and 3, were prepared in the following way:

The elastomer, the reinforcing filler and also the various other ingredients, with the exception of the dithiosulfate salt, of the diphenylguanidine, of the sulfur and of the vulcanization accelerator, are successively introduced into an internal mixer (final degree of filling: approximately 70% by volume), the initial vessel temperature of which is approximately 80° C. Thermomechanical working (non-productive phase) is then carried out in one stage, which lasts in total approximately from 3 to 4 min, until a maximum “dropping” temperature of 165° C. is reached. The mixture thus obtained is recovered and cooled and then the diphenylguanidine or the dithiosulfate salt, the sulfur and the vulcanization accelerator are introduced on a mixer (homofinisher) at 30° C., everything being mixed (productive phase) for an appropriate time (for example, approximately ten minutes).

All the rubber compositions contain a saturated elastomer. The rubber compositions I1 to I6 are rubber compositions, the vulcanization system of which comprises a dithiosulfate salt. The compositions I1 to I3 differ from one another in the content of dithiosulfate salt (1 phr, 1.5 phr and 2 phr respectively). The rubber compositions 14 to 16 are rubber compositions, the vulcanization system of which comprises 1.5 phr of a dithiosulfate salt, and they are different from one another in the content of natural rubber (5 phr, 10 phr and 20 phr respectively). The rubber composition C1, a control composition, differs from the compositions I1 to I3 in that it does not contain a dithiosulfate salt. The rubber composition C2, a comparative composition, differs from I1 to I3 in that it contains diphenylguanidine (1.5 phr) instead of the dithiosulfate salt. The rubber compositions C3 to C5, compositions which are respectively comparative to I4, I5 and I6, different from 14 to 16 in that they do not contain a dithiosulfate salt. The rubber compositions C6 to C8, compositions which are respectively comparative to I4, I5 and I6, differ from I4 to I6 in that they contain diphenylguanidine (1.5 phr) instead of the dithiosulfate salt. The compositions thus obtained are subsequently calendered, either in the form of plaques (thickness of 2 to 3 mm) or of thin sheets of rubber, for the measurement of their physical or mechanical properties, or extruded. The vulcanization properties at 150° C. and the dynamic properties of the rubber compositions are measured after T95 curing at 150° C.

### 3 Results:

The results appear in Table 2 and Table 4.

For the control composition C1, the time necessary for the start of the vulcanization reaction is greater than 15 minutes. The compositions I1 to I3, which contain the dithiosulfate salt, begin to vulcanize at a time which is much less than 15 min (respectively 13, 11 and 9.5 minutes): the addition of a dithiosulfate salt makes it possible to reduce this time necessary for the initiation of the vulcanization by up to more than 30%. This earlier initiation of the vulcanization thus makes it possible to reduce the in-press curing time. This result is obtained without being detrimental to the stiffening, since the stiffnesses of the compositions I1 to I3 are of the same order of magnitude as the control composition C1. Moreover, it is also noted that the hysteresis of the compositions I1 to I3 is virtually identical to that of the control composition C1. It is also observed that a variation of 1 phr to 2 phr in dithiosulfate salt is accompanied by a variation in tan(δ)max of at most 0.02 point. The insignificant influence of the dithiosulfate content on the hysteresis presents an advantage in the preparation of the rubber compositions, since it ensures a consistency in the hysteresis properties despite variations in the dithiosulfate content which can range up to 100%. The advantage of the dithiosulfate salt is confirmed in the compositions 14 to 16 containing natural rubber, with respect to the control compositions C3 to C5 respectively.

On the other hand, the addition of diphenylguanidine does not give a compromise between the vulcanization properties and the dynamic properties which is as advantageous as the dithiosulfate salt at the same content (1.5 phr). The reduction in the time necessary for the start of the vulcanization reaction obtained with diphenylguanidine is made to the detriment of the compromise in stiffness and hysteresis properties, the hysteresis being greatly increased with respect to the control composition C1. In the compositions C6 to C8 containing natural rubber, the addition of diphenylguanidine degrades even more the compromise in Ti, stiffness and hysteresis properties, with respect to the compositions C3 to C5 respectively. The compositions C6 to C8 exhibit too great a reduction in the Ti and too great an increase in the hysteresis.

To sum up, the use of the dithiosulfate salt makes it possible to reduce the residence time in the curing press of a rubber composition containing the highly saturated elastomer while conferring, on the rubber composition, an acceptable compromise between the stiffness and hysteresis properties. Likewise, this compromise is improved in comparison with that obtained in the case where a well-known vulcanization activator, such as diphenylguanidine, is used instead.

TABLE 1

| Composition | C1 | C2 | I1 | I2 | I3 |
|---|---|---|---|---|---|
| Elastomer (1) | 100 | 100 | 100 | 100 | 100 |
| Carbon black (2) | 40 | 40 | 40 | 40 | 40 |
| Antioxidant (3) | 2.0 | 2.0 | 2.0 | 2.0 | 2.0 |
| Paraffin | 1.0 | 1.0 | 1.0 | 1.0 | 1.0 |
| Stearic acid (4) | 1.5 | 1.5 | 1.5 | 1.5 | 1.5 |
| Zinc oxide (5) | 2.5 | 2.5 | 2.5 | 2.5 | 2.5 |
| Accelerator (6) | 1.3 | 1.3 | 1.3 | 1.3 | 1.3 |
| Sulfur | 0.6 | 0.6 | 0.6 | 0.6 | 0.6 |
| DPG (7) | 0 | 1.5 | 0 | 0 | 0 |
| Dithiosulfate salt (8) | 0 | 0 | 1.0 | 1.5 | 2.0 |

(1) Elastomer containing 71% unit UA, 8% unit UB, 14% unit UC and 7% unit UD (mol %), prepared according to a process for the polymerization of ethylene and butadiene in accordance with Example 4-2 of Patent EP 1 954 705 B1 on behalf of the Applicant Companies, the polymerization time being adjusted so as to obtain a molar mass Mn = 153 000 g/mol with a polydispersity index equal to 1.4
(2) Carbon black of N234 grade according to Standard ASTM D-1765
(3) N-(1,3-Dimethylbutyl)-N′-phenyl-para-phenylenediamine, Santoflex 6-PPD from Flexsys
(4) Stearin, Pristerene 4931 from Uniqema
(5) Zinc oxide of industrial grade from Umicore
(6) N-Cyclohexyl-2-benzothiazolesulfenamide, Santocure CBS from Flexsys
(7) Diphenylguanidine
(8) Disodium hexamethylene-1,6-bisthiosulfate dihydrate

TABLE 2

| Composition | C1 | C2 | I1 | I2 | I3 |
|---|---|---|---|---|---|
| Ti (min) | 15.5 | 6.5 | 13 | 11 | 9.5 |
| G* (MPa) | 1.60 | 1.89 | 1.52 | 1.59 | 1.55 |
| tan(δ)max | 0.18 | 0.26 | 0.19 | 0.18 | 0.20 |

TABLE 3

| Composition | C3 | C4 | C5 | C6 | C7 | C8 | I4 | I5 | I6 |
|---|---|---|---|---|---|---|---|---|---|
| Elastomer (1) | 95 | 90 | 80 | 95 | 90 | 80 | 95 | 90 | 80 |
| Elastomer (2) | 5 | 10 | 20 | 5 | 10 | 20 | 5 | 10 | 20 |
| Carbon black (3) | 40 | 40 | 40 | 40 | 40 | 40 | 40 | 40 | 40 |
| Antioxidant (4) | 2.0 | 2.0 | 2.0 | 2.0 | 2.0 | 2.0 | 2.0 | 2.0 | 2.0 |
| Paraffin | 1.0 | 1.0 | 1.0 | 1.0 | 1.0 | 1.0 | 1.0 | 1.0 | 1.0 |
| Stearic acid (5) | 1.5 | 1.5 | 1.5 | 1.5 | 1.5 | 1.5 | 1.5 | 1.5 | 1.5 |
| Zinc oxide (6) | 2.5 | 2.5 | 2.5 | 2.5 | 2.5 | 2.5 | 2.5 | 2.5 | 2.5 |
| Accelerator (7) | 1.3 | 1.3 | 1.3 | 1.3 | 1.3 | 1.3 | 1.3 | 1.3 | 1.3 |
| Sulfur | 0.6 | 0.6 | 0.6 | 0.6 | 0.6 | 0.6 | 0.6 | 0.6 | 0.6 |
| DPG (8) | 0 | 0 | 0 | 1.5 | 1.5 | 1.5 | 0 | 0 | 0 |
| Dithiosulfate salt (9) | 0 | 0 | 0 | 0 | 0 | 0 | 1.5 | 1.5 | 1.5 |

(1) Elastomer containing 71% unit UA, 8% unit UB, 14% unit UC and 7% unit UD (mol %), prepared according to a process for the polymerization of ethylene and butadiene in accordance with Example 4-2 of Patent EP 1 954 705 B1 on behalf of the Applicant Companies, the polymerization time being adjusted so as to obtain a molar mass Mn = 153 000 g/mol with a polydispersity index equal to 1.4
(2) Natural rubber
(3) Carbon black of N234 grade according to Standard ASTM D-1765
(4) N-(1,3-Dimethylbutyl)-N′-phenyl-para-phenylenediamine, Santoflex 6-PPD from Flexsys
(5) Stearin, Pristerene 4931 from Uniqema
(6) Zinc oxide of industrial grade from Umicore
(7) N-Cyclohexyl-2-benzothiazolesulfenamide, Santocure CBS from Flexsys
(8) Diphenylguanidine
(9) Disodium hexamethylene-1,6-bisthiosulfate dihydrate

TABLE 4

| Composition | C3 | C4 | C5 | C6 | C7 | C8 | I4 | I5 | I6 |
|---|---|---|---|---|---|---|---|---|---|
| Ti (min) | 12.0 | 11.3 | 10.6 | 0.3 | 0.0 | 0.0 | 8.9 | 9.7 | 9.1 |
| G* (MPa) | 1.85 | 1.83 | 1.70 | 1.84 | 1.85 | 1.72 | 1.88 | 1.84 | 1.75 |
| tan(δ)max | 0.20 | 0.20 | 0.21 | 0.26 | 0.27 | 0.26 | 0.20 | 0.21 | 0.21 |

1. A rubber composition based at least on an elastomer matrix, on a reinforcing filler and on a vulcanization system, the elastomer matrix comprising a highly saturated elastomer and from 0 to less than 30 phr of natural rubber, the highly saturated diene elastomer containing 1,3-diene units and more than 50 mol % of ethylene units, the vulcanization system comprising a dithiosulfate salt of formula (I):
MO₃S—S-A-S—SO₃M (I)
the symbol A representing an alkanediyl group or a group comprising two or more alkanediyl units, which units are connected in pairs via an oxygen or sulfur atom, via a group of formula —SO₂—, —NH—, —NH₂⁺—, —N(C₁-C₁₆ alkyl)- or —COO—, or via an arylene or cycloalkylene group, and the symbol M representing a metal atom.

2. A rubber composition according to claim 1, in which the highly saturated elastomer contains more than 60 mol % of ethylene unit.

3. A rubber composition according to claim 1, in which the 1,3-diene is 1,3-butadiene.

4. A rubber composition according to claim 3, in which the highly saturated elastomer contains UD units of formula (I):

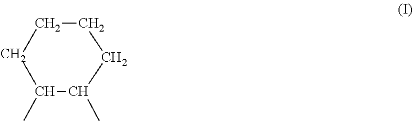

5. A rubber composition according to claim 4, in which the highly saturated elastomer contains the following units UA, units UB, units UC, units UD and units UE distributed randomly:
UA) —CH₂—CH₂— according to a molar percentage of m %
UB) —CH₂—CH═CH—CH₂— according to a molar percentage of n %
UC) —CH₂—CH(CH═CH₂)— according to a molar percentage of o %
UD) 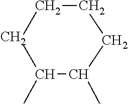
according to a molar percentage of p %
UE) 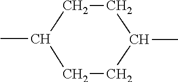
according to a molar percentage of q %
m, n, o, p and q being numbers ranging from 0 to 100,
m>50
n+o>0
p>0
q≥0,
the respective molar percentages of m, n, o, p and q being calculated on the basis of the sum of m+n+o+p+q, which is equal to 100.

6. A rubber composition according to claim 5, in which:
0<o+p≤25
o+p+q≥5
n+o>0
q≥0,
the respective molar percentages of m, n, o, p and q being calculated on the basis of the sum of m+n+o+p+q, which is equal to 100.

7. A rubber composition according to claim 5, in which the highly saturated elastomer exhibits at least one of the following criteria:
a. m≥65
b. n+o+p+q≥15
c. 10≥p+q≥2
d. 1≥n/(o+p+q)
e. when q is non-zero, 20≥p/q≥1.

8. A rubber composition according to claim 5, in which q is equal to 0.

9. A rubber composition according to claim 1, in which the highly saturated elastomer is a copolymer of 1,3-butadiene and of ethylene.

10. A rubber composition according to claim 1, in which the rubber composition contains more than 70 phr of the highly saturated elastomer.

11. A rubber composition according to claim 1, in which the rubber composition contains more than 90 phr of the highly saturated elastomer.

12. A rubber composition according to claim 1, in which M denotes an alkali metal atom, an alkaline earth metal atom or a transition metal atom.

13. A rubber composition according to claim 1, in which M denotes a sodium or potassium atom.

14. A rubber composition according to claim 1, in which A denotes an alkanediyl group of formula —(CH₂)ₙ—, n being an integer ranging from 3 to 10.

15. A rubber composition according to claim 1, in which A denotes a 1,6-hexanediyl group.

16. A rubber composition according to claim 1, in which the content of dithiosulfate salt represents from 0.5 to 5.

17. A rubber composition according to claim 1, in which the reinforcing filler comprises a carbon black.

18. A rubber composition according to claim 1, in which the vulcanization system comprises sulfur and a vulcanization accelerator.

19. A process for the manufacture of a rubber composition defined according to claim 1, which comprises the following stages:
a. incorporating, in the elastomer matrix, the reinforcing filler and, if appropriate, other ingredients of the rubber composition, with the exception of the dithiosulfate salt, of the sulfur and of vulcanization accelerator constituting the vulcanization system,
b. thermomechanically kneading the mixture obtained in stage a) until a maximum temperature of between 110° C. and 190° C. is reached,
c. cooling the combined mixture to a temperature of less than 100° C.,
d. subsequently incorporating the dithiosulfate salt, the sulfur and the vulcanization accelerator,
e. kneading everything up to a maximum temperature of less than 110° C., in order to obtain a rubber composition.
